(19) United States
(12) Patent Application Publication
(10) Pub. No.: US 2020/0413312 A1
(43) Pub. Date: Dec. 31, 2020

(54) NETWORK SIGNALLING CONDITIONAL HANDOVER

(71) Applicants: Jaemin Han, Portland, OR (US); Alexander Sirotkin, Tel-Aviv (IL)

(72) Inventors: Jaemin Han, Portland, OR (US); Alexander Sirotkin, Tel-Aviv (IL)

(21) Appl. No.: 17/017,980

(22) Filed: Sep. 11, 2020

Related U.S. Application Data
(60) Provisional application No. 62/905,061, filed on Sep. 24, 2019.
(60) Provisional application No. 62/905,072, filed on Sep. 24, 2019.

(51) Int. Cl. H04W 36/08; H04W 36/00

(52) U.S. Cl. CPC H04W 36/08; H04W 36/0033; H04W 36/0072

(57) ABSTRACT

Systems and methods for conditional handover are described. The source cell sends a Handover Request (HR) message to a target cell. The target cell indicates in a HR Acknowledgment message whether a full or delta configuration was used in the HandoverCommand message in the HR Acknowledgment message. If the source configuration changes before handover, the source cell can use the target configuration information to avoid transmission of another HR message if the full configuration was indicated. The if the source configuration changes, the other HR message indicates whether UE context and/or history information should be processed by the target cell. If the target cell configuration or prepared target cell resources for the handover have changed prior to handover to the target cell, the target cell sends a CHO Cancel message with a cause IE indicating the change of the target cell configuration or prepared resources.

### PRIORITY CLAIM

This application claims the benefit of priority under 35 U.S.C. 119(e) to U.S. Provisional Patent Application Ser. No. 62/905,061, filed Sep. 24, 2019 and U.S. Provisional Patent Application Ser. No. 62/905,072, filed Sep. 24, 2019, each of which is incorporated herein by reference in its entirety.

### TECHNICAL FIELD

Embodiments pertain to conditional handover in new radio (NR) or fifth generation (5G) systems. Some embodiments relate to reducing signaling for conditional handover.

### BACKGROUND

The use of 3GPP networks has increased due to both an increase in the types of devices user equipment (UEs) using network resources as well as the amount of data and bandwidth being used by various applications, such as video streaming, operating on these UEs. The 5G network, which like previous generations of networks includes both a radio-access network (RAN) and a core network (CN), has been developed to answer the enormous increase in number and diversity of communication devices. The advent of the increased flexibility provided by 5G systems, has engendered a host of issues, such as reducing the signaling complexity during handover, and in particular conditional handover.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates Conditional Handover Messages in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

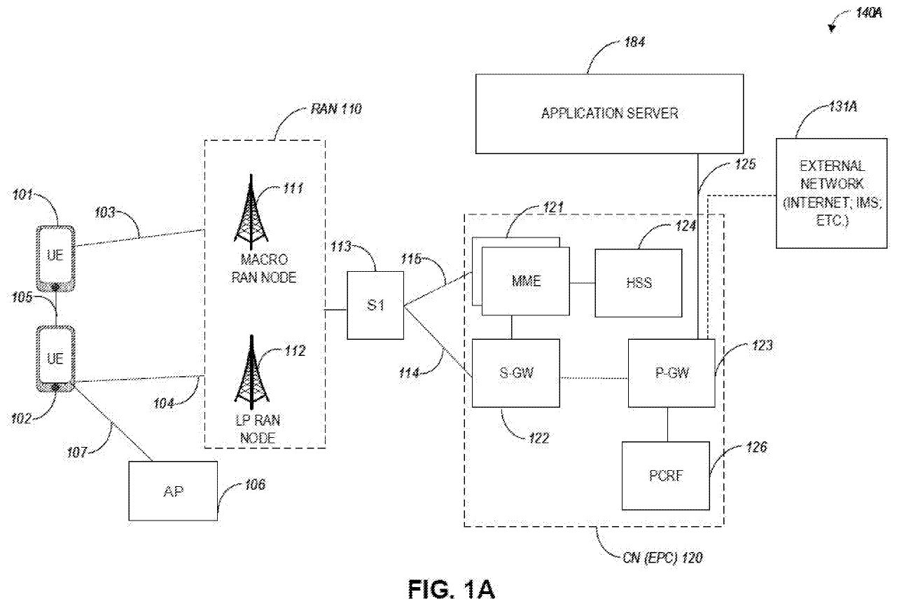

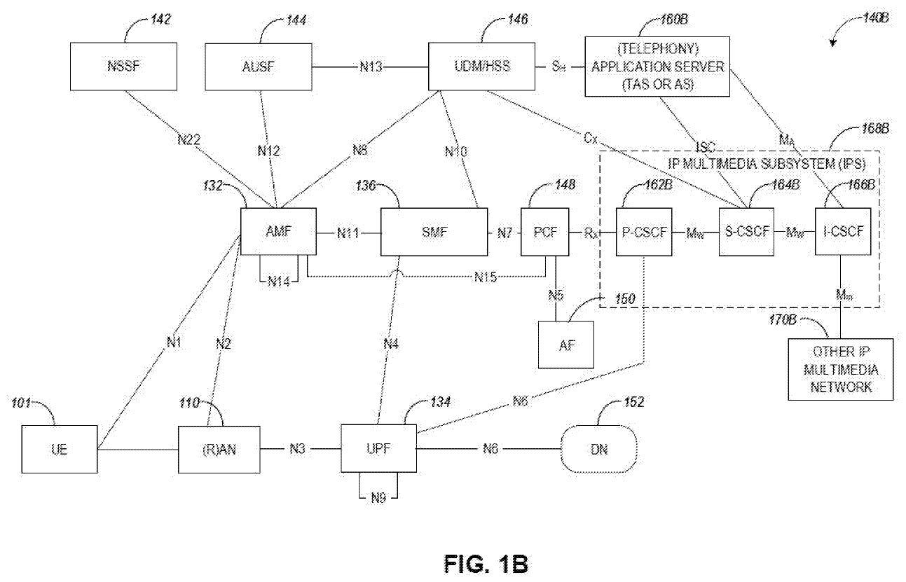

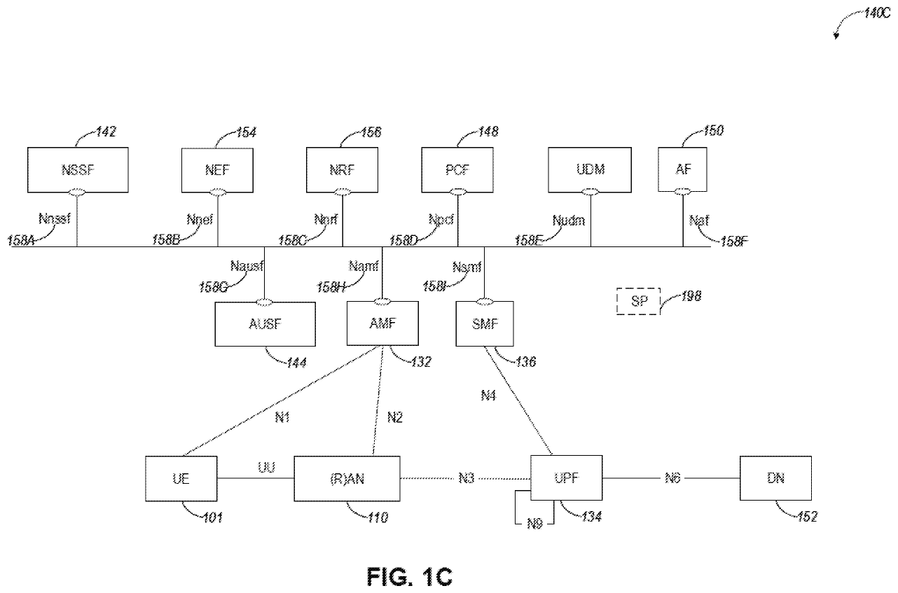

FIG. 1A illustrates an architecture of a network in accordance with some aspects. The network 140A includes 3GPP LTE/4G and NG network functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or OFDM modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-IC). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018 December). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular. FIG. 1B illustrates a 5G system architecture 140B in a reference point representation. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown). N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N 13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown). N16 (between two SMFs, not shown), and N22 (between AMF 132 and NSSF 142, not shown). Other reference point representations not shown in FIG. 1E can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

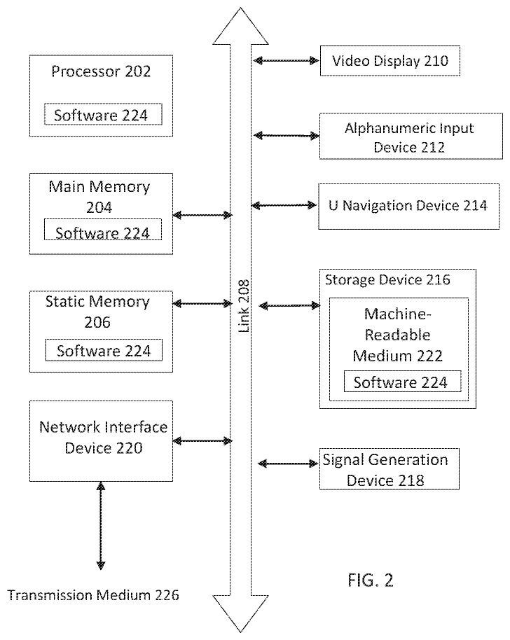

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIG. 1.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks: Radio access Memory (RAM); and CD-ROM and DVD-ROM disks.

The instructions 224 may further be transmitted or received over a communications network using a transmission medium 226 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi. IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

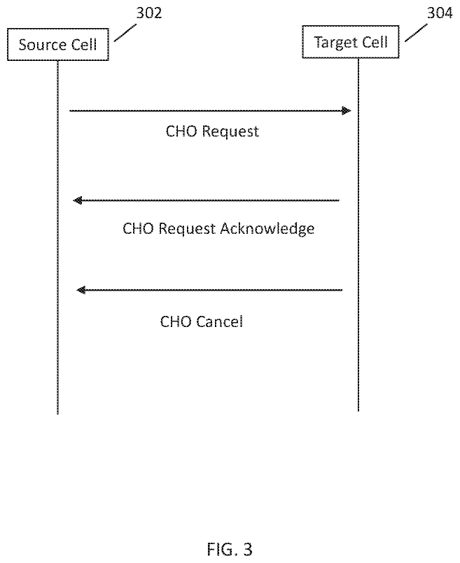

As indicated above, conditional handover (CHO) may be used to increase handover reliability. In brief, the source cell serving the UE may determine that the UE is to perform handover. FIG. 3 illustrates Conditional Handover Messages in accordance with some embodiments. As shown, the source cell 302 may send a handover request message (CHO Request) with an information element (IE) indicating conditional handover (Conditional Handover Information IE) to one or more target cells 304. Each message described herein may be encoded prior to transmission by the transmitting entity and decoded after reception by the receiving entity. Each target cell may, in response to acceptance of the CHO Request message, transmit to the source cell a handover request acknowledgment (CHO Request Acknowledge), which may contain the conditional handover information IE (or, if the target cell does not admit at least one PDU session resource or failure occurs during handover preparation, a handover preparation failure message containing a requested target cell ID IE). The handover request acknowledgment message may contain parameters and handover condition for that target cell (Conditional Handover Information IE). The source cell may relay the conditional handover information to the UE in a handover command, where the parameters and handover conditions are stored. The handover command may thus contain the handover condition to be monitored by the UE for each target cell, which may differ between target cells. The condition may relate to the Radio Signal Received Power (RSRP) and/or Radio Signal Received Quality (RSRQ) based on measurements of reference signals from the source cell and/or target cells. When the condition is fulfilled, the UE may initiate handover without sending a measurement report to the source cell and subsequently waiting to receive the handover command from the source cell.

Thus, one or more target cells may be prepared in advance for handover by the UE using CHO, and the UE selects among these target cells and accesses a single target cell satisfying configured conditions. This process may take a relatively long time (e.g., >100 ms). Due to preparation of what can be a relatively large number of target cells, the network load in terms of signaling and resource pre-allocation is much higher than with conventional handover. Moreover, even if several target cells are prepared and configured for handover of the UE, either a source cell or a target cell can modify already prepared resources and/or commands, a process that may occur on a much shorter time scale (e.g., tens of ms or <10 ms) than the CHO time period. This, in turn, incurs more frequent communication between the over the X2 (eNB-eNB) or XnAP (gNB-gNB) interface and more processing complexity on the source and target nodes (note that the term “node” is used herein synonymously with the term “cell” or the term “eNB” for 4G/LTE or “gNB” for 5G, although it is clear that, for example, the processing circuitry in an eNB/gNB may configure the eNB/gNB to operate as a source/target cell). As a result, it may be desirable under these circumstances to optimize signaling and reduce processing burdens in the network side.

When CHO is to occur, the source cell and target cell exchange configurations to help the target cell prepare follow-up configurations. The target cell may decide whether to perform a full configuration or a delta configuration based on the current configuration of the source cell (the source configuration). If a full configuration was transmitted from the target cell to the source cell (and then relayed to the UE), if the source cell has modified the resources for the UE, further signaling between the source cell and the target cell may be avoided. However, this is not the case if the delta configuration was transmitted by the target cell.

Thus, to minimize such signaling in a first embodiment, the target cell may inform the source cell whether the target cell has generated a full or delta configuration CHO command when sending a CHO command. The delta configuration CHO command, as above, may be based on the latest source configuration. As a result, the source cell may trigger CHO modification to a target cell, so that the target cell can update its CHO command if delta configuration was used. If the source cell can determine whether a target cell generated a delta or full configuration for its CHO command (e.g., by an RRC IE), then the source cell can skip triggering CHO modification to a target cell who generated a full configuration, which can save network signaling.

Some example implementations in TS 36.423 v15.6.0 (2019 Jul. 16) and TS 38.423 v15.4.0 (2019 Jul. 16) are as follows:

For TS 36.423

9.1.1.2 Handover Request Acknowledge

This message is sent by the target eNB to inform the source eNB about the prepared resources at the target.

Direction: target eNB→source eNB.

| IE/Group | | | IE type and | Semantics | | Assigned |
|---|---|---|---|---|---|---|
| Name | Presence | Range | reference | description | Criticality | Criticality |
| Message | M | | 9.2.13 | | YES | reject |
| Type | | | | | | |
| Old eNB | M | | eNB UE | Allocated at | YES | ignore |
| UE X2AP | | | X2AP ID | the source | | |
| ID | | | 9.2.24 | eNB | | |
| New eNB | M | | eNB UE | Allocated at | YES | ignore |
| UE X2AP | | | X2AP ID | the target eNB | | |
| ID | | | 9.2.24 | | | |
| E-RABs | | 1 | | | YES | ignore |
| Admitted | | | | | | |
| List | | | | | | |
| >E-RABs | | 1 . . . <maxnoofBearers> | | | EACH | ignore |
| Admitted | | | | | | |
| Item | | | | | | |
| >>E- | M | | 9.2.23 | | — | |
| RAB ID | | | | | | |
| >>UL | O | | GTP Tunnel | Identifies the | — | |
| GTP | | | Endpoint | X2 transport | | |
| Tunnel | | | 9.2.1 | bearer used for | | |
| Endpoint | | | | forwarding of | | |
| | | | | UL PDUs | | |
| >>DL | O | | GTP Tunnel | Identifies the | — | |
| GTP | | | Endpoint | X2 transport | | |
| Tunnel | | | 9.2.1 | bearer. used | | |
| Endpoint | | | | for forwarding | | |
| | | | | of DL PDUs | | |
| E-RABs | O | | E-RAB List | A value for E- | YES | ignore |
| Not | | | 9.2.28 | RAB ID shall | | |
| Admitted | | | | only be present | | |
| List | | | | once in E- | | |
| | | | | RABs Admitted | | |
| | | | | List IE and in | | |
| | | | | E-RABs Not | | |
| | | | | Admitted List | | |
| | | | | IE. | | |
| Target eNB | M | | OCTET | Includes the | YES | ignore |
| To Source | | | STRING | RRC E-UTRA | | |
| eNB | | | | Handover | | |
| Transparent | | | | Command | | |
| Container | | | | message as | | |
| | | | | defined in | | |
| | | | | subclause | | |
| | | | | 10.2.2 in TS | | |
| | | | | 36.331 [9] | | |
| HO | O | | ENUMERATED | Indicates | Yes | ignore |
| Command | | | (delta, . . .) | whether delta | | |
| Information | | | | or full | | |
| | | | | configuration | | |
| | | | | was used to | | |
| | | | | generate | | |
| | | | | HandoverCommand | | |
| | | | | message. | | |
| Criticality | O | | 9.2.7 | | YES | ignore |
| Diagnostics | | | | | | |
| UE Context | O | | 9.2.85 | | YES | ignore |
| Kept | | | | | | |
| Indicator | | | | | | |
| Old eNB | O | | Extended | Allocated at | YES | ignore |
| UE X2AP | | | eNB UE | the source | | |
| ID | | | X2AP ID | eNB | | |
| Extension | | | 9.2.86 | | | |
| New eNB | O | | Extended | Allocated at | YES | reject |
| UE X2AP | | | eNB UE | the target eNB | | |
| ID | | | X2AP ID | | | |
| Extension | | | 9.2.86 | | | |
| WT UE | O | | UE Context | Indicates that | YES | ignore |
| Context | | | Kept | the WT has | | |
| Kept | | | Indicator | acknowledged | | |
| Indicator | | | 9.2.85 | to keep the UE | | |
| | | | | context | | |

| Range bound | Explanation |
|---|---|
| maxnoofBearers | Maximum no. of E-RABs. Value is 256 |

For TS 38.423

9.1.1.2 Handover Request Acknowledge

This message is sent by the target NG-RAN node to inform the source NG-RAN node about the prepared resources at the target.

Direction: target NG-RAN node→source NG-RAN node.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message Type | M | 9.2.3.1 | | YES | reject |
| Source NG-RAN | M | NG-RAN node | Allocated at the source | YES | ignore |
| node UE XnAP | | UE XnAP ID | NG-RAN node | | |
| ID | | 9.2.3.16 | | | |
| Target NG-RAN | M | NG-RAN node | Allocated at the target | YES | ignore |
| node UE XnAP | | UE XnAP ID | NG-RAN node | | |
| ID | | 9.2.3.16 | | | |
| PDU Session | M | 9.2.1.2 | | YES | ignore |
| Resources | | | | | |
| Admitted List | | | | | |
| PDU Session | O | 9.2.1.3 | | YES | ignore |
| Resources Not | | | | | |
| Admitted List | | | | | |
| Target NG-RAN | M | OCTET STRING | Either includes the | YES | ignore |
| node To Source | | | HandoverCommand | | |
| NG-RAN node | | | message as defined in | | |
| Transparent | | | subclause 10.2.2 of TS | | |
| Container | | | 36.331 [14], if the target | | |
| | | | NG-RAN node is an | | |
| | | | ng-eNB, or the | | |
| | | | HandoverCommand | | |
| | | | message as defined in | | |
| | | | subclause 11.2.2 of TS | | |
| | | | 38.331 [10], if the target | | |
| | | | NG-RAN node is a gNB. | | |
| HO Command | O | ENUMERATED | Indicates whether delta | Yes | ignore |
| Information | | (delta, full, . . .) | or full configuration | | |
| | | | was used to generate | | |
| | | | HandoverCommand | | |
| | | | message. | | |
| UE Context Kept | O | 9.2.3.68 | | YES | ignore |
| Indicator | | | | | |
| Criticality | O | 9.2.3.3 | | YES | ignore |
| Diagnostics | | | | | |

As an alternative, the HO Command Information information element (IE) can be a Boolean type to indicate full configuration as in the following:

| | | | | | |
|---|---|---|---|---|---|
| HO Command Full Config | O | ENUMERATED | Indicates full | Yes | ignore |
| | | (True, . . .) | configuration was | | |
| | | | used to generate | | |
| | | | HandoverCommand | | |
| | | | message. | | |

In a second embodiment, the source cell indicates to the target cell whether re-processing of mandatory IEs in the handover request (HO REQ) message is to be performed. If the existing HO REQ/ACK is re-used for modification of CHO configurations, then the mandatory IEs (such as UE Context or History-related IEs) which are transferred in the HO REQ message, even if unchanged, would be re-processed again by a target cell. Providing an indication from the source cell whether re-processing is to be performed may help reduce processing burden in the target cell.

In this embodiment, TS 36.423 and TS 38.423 are as follows:

For TS 36.423

9.1.1.1 Handover Request

This message is sent by the source eNB to the target eNB to request the preparation of resources for a handover.

Direction: source eNB→target eNB.

| IE/Group | | | IE type and | Semantics | | Assigned |
|---|---|---|---|---|---|---|
| Name | Presence | Range | reference | description | Criticality | Criticality |
| Message Type | M | | 9.2.13 | | YES | reject |
| Old eNB UE | M | | eNB UE | Allocated at the | YES | reject |
| X2AP ID | | | X2AP ID | source eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE | M | | INTEGER | MME UE S1AP ID allocated | — | |
| S1AP ID | | | (0 . . . 2³² − 1) | at the MME | | |
| >UE Security | M | | 9.2.29 | | — | |
| Capabilities | | | | | | |
| >AS Security | M | | 9.2.30 | | — | |
| Information | | | | | | |
| >UE | M | | 9.2.12 | | — | |
| Aggregate | | | | | | |
| Maximum Bit | | | | | | |
| Rate | | | | | | |
| Subscriber | O | | 9.2.25 | | — | |
| Profile ID for | | | | | | |
| RAT/Frequency | | | | | | |
| priority | | | | | | |
| >E-RABs To | | 1 | | | — | |
| Be Setup | | | | | | |
| List | | | | | | |
| >>E-RABs | | 1 . . . <maxnoofBearers> | | | EACH | ignore |
| To Be | | | | | | |
| Setup Item | | | | | | |
| >>>E- | M | | 9.2.23 | | — | |
| RAB ID | | | | | | |
| >>>E- | M | | 9.2.9 | Includes necessary QoS | — | |
| RAB Level | | | | parameters | | |
| QoS | | | | | | |
| Parameters | | | | | | |
| >>>DL | O | | 9.2.5 | | — | |
| Forwarding | | | | | | |
| >>>UL | M | | GTP | SGW endpoint of the S1 | — | |
| GTP | | | Tunnel | transport bearer. For | | |
| Tunnel | | | Endpoint | delivery of UL PDUs. | | |
| Endpoint | | | 9.2.1 | | | |
| >>>Bearer | O | | 9.2.92 | | YES | reject |
| Type | | | | | | |
| >RRC | M | | OCTET | Includes the RRC | — | |
| Context | | | STRING | HandoverPreparationInformation | | |
| | | | | message as defined in | | |
| | | | | subclause 10.2.2 of TS | | |
| | | | | 36.331 [9], or the RRC | | |
| | | | | HandoverPreparationInformation- | | |
| | | | | NB message as defined in | | |
| | | | | 10.6.2 of TS 36.331 [9\|. | | |
| >Handover | O | | 9.2.3 | | — | |
| Restriction | | | | | | |
| List | | | | | | |
| >Location | O | | 9.2.21 | Includes the necessary | — | |
| Reporting | | | | parameters for location | | |
| Information | | | | reporting | | |
| >Management | O | | 9.2.59 | | YES | ignore |
| Based MDT | | | | | | |
| Allowed | | | | | | |
| >Management | O | | MDT PLMN | | YES | ignore |
| Based | | | List | | | |
| MDT PLMN | | | 9.2.64 | | | |
| List | | | | | | |
| >UE Sidelink | O | | 9.2.97 | This IE applies only if | YES | Ignore |
| Aggregate | | | | the UE is authorized for | | |
| Maximum Bit | | | | V2X services. | | |
| Rate | | | | | | |
| UE History | M | | 9.2.38 | Same definition as in | YES | ignore |
| Information | | | | TS 36.413 [4] | | |
| Trace | O | | 9.2.2 | | YES | ignore |
| Activation | | | | | | |
| SRVCC | O | | 9.2.33 | | YES | ignore |
| Operation | | | | | | |
| Possible | | | | | | |
| CSG | O | | 9.2.52 | | YES | reject |
| Membership | | | | | | |
| Status | | | | | | |
| Mobility | O | | BIT | Information related to the | YES | ignore |
| information | | | STRING | handover; the source eNB | | |
| | | | (SIZE (32)) | provides it in order to | | |
| | | | | enable later analysis of | | |
| | | | | the conditions that led to | | |
| | | | | a wrong HO. | | |
| Masked | O | | 9.2.69 | | YES | ignore |
| IMEISV | | | | | | |
| UE History | O | | OCTET | VisitedCellInfoList | YES | ignore |
| Information | | | STRING | contained in the | | |
| from the UE | | | | UEInformationResponse | | |
| | | | | message (TS 36.331 [9]) | | |
| Expected UE | O | | 9.2.70 | | YES | ignore |
| Behaviour | | | | | | |
| ProSe | O | | 9.2.78 | | YES | ignore |
| Authorized | | | | | | |
| UE Context | O | | | | YES | ignore |
| Reference at | | | | | | |
| the SeNB | | | | | | |
| >Global | M | | Global eNB | | | |
| SeNB ID | | | ID | | | |
| | | | 9.2.22 | | | |
| >SeNB UE | M | | eNB UE | Allocated at the SeNB | | |
| X2AP ID | | | X2AP ID | | | |
| | | | 9.2.24 | | | |
| >SeNB UE | O | | Extended | Allocated at the SeNB | | |
| X2AP ID | | | eNB UE | | | |
| Extension | | | X2AP ID | | | |
| | | | 9.2.86 | | | |
| Old eNB UE | O | | Extended | Allocated at the source eNB | YES | reject |
| X2AP ID | | | eNB UE | | | |
| Extension | | | X2AP ID | | | |
| | | | 9.2.86 | | | |
| V2X Services | O | | 9.2.93 | | YES | ignore |
| Authorized | | | | | | |
| UE Context | O | | | | YES | ignore |
| Reference at | | | | | | |
| the WT | | | | | | |
| >WT ID | M | | 9.2.95 | | | |
| >WT UE XwAP | M | | 9.2.96 | | | |
| ID | | | | | | |
| UE Context | O | | | | YES | ignore |
| Reference at | | | | | | |
| the SgNB | | | | | | |
| >Global en- | M | | 9.2.112 | | | |
| gNB ID | | | | | | |
| >SgNB UE | M | | en-gNB UE | Allocated at the SgNB. | — | |
| X2AP ID | | | X2AP ID | | | |
| | | | 9.2.100 | | | |
| NR UE Security | O | | 9.2.107 | | YES | ignore |
| Capabilities | | | | | | |
| Aerial UE | O | | 9.2.129 | | YES | ignore |
| subscription | | | | | | |
| information | | | | | | |
| Subscription | O | | 9.2.136 | | YES | ignore |
| Based UE | | | | | | |
| Differentiation | | | | | | |
| Information | | | | | | |
| Reprocessing | O | | ENUMIERATED | Information whether | YES | ignore |
| Information | | | (Reprocessing | reprocessing of UE | | |
| | | | UE Context | Context Information IE | | |
| | | | Required, | or UE History Information | | |
| | | | Reprocessing | IE or both is required for | | |
| | | | UE History | CHO modification | | |
| | | | Required, | | | |
| | | | Both, . . .) | | | |

| Range bound | Explanation |
|---|---|
| maxnoofBearers | Maximum no. of E-RABs. Value is 256 |
| maxnoofMDTPLMNs | PLMNs in the Management Based MDT PLMN list. Value is 16. |

The UE History Information IE contains information about cells that a UE has been served by in active state prior to the target cell. The UE Context Information contains the UE context information within the RETRIEVE UE CONTEXT RESPONSE message.

For TS 38.423

9.1.1.1 Handover Request

This message is sent by the source NG-RAN node to the target NG-RAN node to request the preparation of resources for a handover.

Direction: source NG-RAN node→target NG-RAN node.

| IE/Group | | | IE type and | Semantics | | Assigned |
|---|---|---|---|---|---|---|
| Name | Presence | Range | reference | description | Criticality | Criticality |
| Message Type | M | | 9.2.3.1 | | YES | reject |
| Source NG-RAN | M | | NG-RAN | Allocated at the | YES | reject |
| node UE XnAP | | | node UE | source NG-RAN | | |
| ID reference | | | XnAP ID | node | | |
| | | | 9.2.3.16 | | | |
| Cause | M | | 9.2.3.2 | | YES | reject |
| Target Cell | M | | 9.2.3.25 | Includes either an | YES | reject |
| Global ID | | | | E-UTRA CGI or an | | |
| | | | | NR CGI | | |
| GUAMI | M | | 9.2.3.24 | | YES | reject |
| UE Context | | 1 | | | YES | reject |
| Information | | | | | | |
| >NG-C UE | M | | AMF UE | Allocated at the | — | |
| associated | | | NGAP ID | AMF on the source | | |
| Signalling | | | 9.2.3.26 | NG-C connection. | | |
| reference | | | | | | |
| >Signailing | M | | CP Transport | This IE indicates | — | |
| TNL | | | Layer | the AMF's IP | | |
| association | | | Information | address of the | | |
| address at | | | 9.2.3.31 | SCTP association | | |
| source NG-C | | | | used at the source | | |
| side | | | | NG-C interface | | |
| | | | | instance. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection | | | | | | |
| Priority | | | | | | |
| >UE Aggregate | M | | 9.2.3.17 | | — | |
| Maximum Bit | | | | | | |
| Rate | | | | | | |
| >PDU Session | | 1 | 9.2.1.1 | Similar to NG-C | — | |
| Resources To | | | | signalling, | | |
| Be Setup List | | | | containing UL | | |
| | | | | tunnel information | | |
| | | | | per PDU Session | | |
| | | | | Resource; | | |
| | | | | and in addition, the | | |
| | | | | source side QoS | | |
| | | | | flow ⇔ DRB | | |
| | | | | mapping | | |
| >RRC Context | M | | OCTET | Either includes the | — | |
| | | | STRING | HandoverPreparationInformation | | |
| | | | | message as defined in | | |
| | | | | subclause 10.2.2. | | |
| | | | | of TS 36.331 [14], if | | |
| | | | | the target NG-RAN | | |
| | | | | node is an ng-eNB, or the | | |
| | | | | HandoverPreparationInformation | | |
| | | | | message as defined in | | |
| | | | | subclause 11.2.2 of | | |
| | | | | TS 38.331 [10], if | | |
| | | | | the target NG-RAN | | |
| | | | | node is a gNB. | | |
| >Location | O | | 9.2.3.47 | Includes the | — | |
| Reporting | | | | necessary | | |
| Information | | | | parameters for | | |
| | | | | location reporting. | | |
| >Mobility | O | | 9.2.3.53 | | — | |
| Restriction List | | | | | | |
| Trace Activation | O | | 9.2.3.55 | | YES | ignore |
| Masked IMEISV | O | | 9.2.3.32 | | YES | ignore |
| UE History | M | | 9.2.3.64 | | YES | ignore |
| Information | | | | | | |
| UE Context | O | | | | YES | ignore |
| Reference at | | | | | | |
| the S-NG-RAN | | | | | | |
| node | | | | | | |
| >Global NG- | M | | 9.2.2.3 | | — | |
| RAN Node ID | | | | | | |
| >S-NG-RAN | M | | NG-RAN | | — | |
| node UE XnAP | | | node UE | | | |
| ID | | | XnAP ID | | | |
| | | | 9.2.3.16 | | | |
| Reprocessing | O | | ENUMERATED | Information whether | YES | ignore |
| Information | | | (Reprocessing | reprocessing of UE | | |
| | | | UE Context | Context Information | | |
| | | | Required, | IE or UE History | | |
| | | | Reprocessing | Information IE or | | |
| | | | UE History | both is required for | | |
| | | | Required, | CHO modification | | |
| | | | Both, . . .) | | | |

Accordingly, either of the above embodiments may reduce the CHO signaling when a CHO modification is triggered from the source cell to a target cell.

In addition, during CHO, once a target cell has been prepared, the target cell can be further modified by a source cell or a target cell before CHO is executed by the UE. Such a modification triggered by a target cell may be able to re-use the existing X2 and Xn CHO Cancel and HO REQ/ACK messages as opposed to introducing new messages, such as new class-1 a target cell initiated CHO MOD REQD/CNFM messages, or CHO MOD REQ/ACK messages similar to those used for Dual Connectivity.

An example of a Conditional Handover Cancel message (shown in FIG. 3) sent by the target node to the source node to cancel an already prepared conditional handover is given by:

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| Source NG- | M | | NG-RAN node | Allocated at | YES | ignore |
| RAN node | | | UE XnAP ID | the source NG- | | |
| UE XnAP ID | | | 9.2.3.16 | RAN node. | | |
| Target NG- | M | | NG-RAN node | Allocated at | YES | reject |
| RAN node | | | UE XnAP ID | the target NG- | | |
| UE XnAP ID | | | 9.2.3.16 | RAN node. | | |
| Cause | M | | 9.2.3.2 | | YES | ignore |
| Candidate | | 0 . . . <maxnoofCellsinCHO> | | | YES | reject |
| Cells To Be | | | | | | |
| Cancelled | | | | | | |
| List | | | | | | |
| >Target | M | | Target Cell | | — | — |
| Cell ID | | | Global ID | | | |
| | | | 9.2.3.25 | | | |

| Range bound | Explanation |
|---|---|
| maxnoofCellsinCHO | Maximum no. cells that can be prepared |
| | for a conditional handover. Value is 8. |

Introduction of such new procedures may complicate CHO operations. Moreover, a class-1 procedure initiated by a target cell may not be suitable, because if a delta configuration was used to generate the CHO command, the modified target configuration may be re-based on the latest source configuration according to the recent RAN2 progress. This may add a roundtrip from the source cell in order for the target cell to send an updated/re-based delta CHO command. Namely, a class-1 procedure from a target cell may not be enough. On the other hand, the existing CHO Cancel with re-triggering CHO preparation may be well-suited to support a CHO modification triggered by a target cell by re-using the existing CHO Cancel and HO REQ/ACK messages.

In a first embodiment, the target cell may trigger a CHO Cancel message and indicate by a cause that re-triggering CHO preparation is expected from the source cell. In this embodiment, since the CHO Cancel message is used for a target cell to indicate cancellation of prepared cells with a cause, this cause can be enhanced to indicate re-triggering of CHO preparation is be performed in order for the target cell to update its target cell configuration.

Some example implementations in TS 36.423 v15.6.0 (2019 Jul. 16) and TS 38.423 v15.4.0 (2019 Jul. 16) are as follows:

For TS 36.423

9.2.6 Cause

The purpose of the cause information element is to indicate the reason for a particular event for the whole protocol.

| | | | | |
|---|---|---|---|---|
| IE/Group | | | | Semantics |
| Name | Presence | Range | IE Type and Reference | Description |

| | | |
|---|---|---|
| CHOICE | M | |
| Cause Group | | |
| >Radio | | |
| Network | | |
| Layer | | |
| >>Radio | M | ENUMERATED |
| Network | | (Handover Desirable for Radio Reasons, |
| Layer | | Time Critical Handover, |
| Cause | | Resource Optimisation Handover, |
| | | Reduce Load in Serving Cell, |
| | | Partial Handover, |
| | | Unknown New eNB UE X2AP ID, |
| | | Unknown Old eNB UE X2AP ID, |
| | | Unknown Pair of UE X2AP ID, |
| | | HO Target not Allowed, |
| | | TX2RELOCoverall Expiry, |
| | | TRELOCprep Expiry, |
| | | Cell not Available, |
| | | No Radio Resources Available in Target |
| | | Cell, |
| | | Invalid MME Group ID, |
| | | Unknown MME Code, Encryption |
| | | And/Or Integrity Protection Algorithms |
| | | Not Supported, |
| | | ReportCharacteristicsEmpty, |
| | | NoReportPeriodicity, |
| | | ExistingMeasurementID, Unknown eNB |
| | | Measurement ID, Measurement |
| | | Temporarily not Available, |
| | | Unspecified, . . . , Load Balancing, |
| | | Handover Optimisation, Value out of |
| | | allowed range, Multiple E-RAB ID |
| | | instances, Switch Off Ongoing, Not |
| | | supported QCI value, Measurement not |
| | | supported for the object, TDCoverall |
| | | Expiry, TDCprep Expiry, |
| | | Action Desirable for Radio Reasons, |
| | | Reduce Load, |
| | | Resource Optimisation, |
| | | Time Critical action, |
| | | Target not Allowed, |
| | | No Radio Resources Available, |
| | | Invalid QoS combination, Encryption |
| | | Algorithms Not Supported, Procedure |
| | | cancelled, RRM purpose, |
| | | Improve user bit rate, |
| | | User Inactivity, |
| | | Radio Connection With UE Lost, Failure |
| | | in the Radio Interface Procedure, |
| | | Bearer Option not Supported, MCG |
| | | Mobility, SCG Mobility, Count reaches |
| | | max value, |
| | | Unknown Old en-gNB UE X2AP ID, |
| | | PDCP Overload, Prepared Tarset Cell |
| | | Configuration Change) |
| >Transport | | |
| Layer | | |
| >>Transport | M | ENUMERATED |
| Layer | | (Transport Resource Unavailable, |
| Cause | | Unspecified, . . .) |
| >Protocol | | |
| >>Protocol | M | ENUMERATED |
| Cause | | (Transfer Syntax Error, Abstract Syntax |
| | | Error (Reject), Abstract Syntax Error |
| | | (Ignore and Notify), Message not |
| | | Compatible with Receiver |
| | | State, Semantic- |
| | | Error, Unspecified, Abstract Syntax Error |
| | | (Falsely Constructed Message), . . .) |
| >Misc | | |
| >>Miscellaneous | M | ENUMERATED |
| Cause | | (Control Processing Overload, |
| | | Hardware Failure, O&M |
| | | Intervention, Not enough User Plane |
| | | Processing Resources, Unspecified, . . .) |

The meaning of the different cause values is described in the following table. In general, “not supported” cause values indicate that the concerned capability is missing. On the other hand, “not available” cause values indicate that the concerned capability is present, but insufficient resources were available to perform the requested action.

| Radio Network | |
|---|---|
| Layer cause | Meaning |
| Cell not Available | The concerned cell is not available. |
| Handover | The reason for requesting handover is radio related. |
| Desirable for | |
| Radio Reasons | |
| Handover Target | Handover to the indicated target cell is not allowed for the UE in |
| not Allowed | question |
| Invalid MME | The target eNB doesn't belong to the same pool area of the source |
| Group ID | eNB for example S1 handovers should be attempted instead. |
| No Radio | The target cell doesn't have sufficient radio resources available. |
| Resources | |
| Available in | |
| Target Cell | |
| Partial Handover | Provides a reason for the handover cancellation. The target eNB did |
| | not admit all E-RABs included in the HANDOVER REQUEST and |
| | the source eNB estimated service continuity for the UE would be |
| | better by not proceeding with handover towards tins particular target |
| | eNB. |
| Reduce Load in | Load in serving cell needs to be reduced. When applied to handover |
| Serving Cell | preparation, it indicates the handover is triggered due to load |
| | balancing. |
| Resource | The reason for requesting handover is to improve the load distribution |
| Optimisation | with the neighbour cells. |
| Handover | |
| Time Critical | Handover is requested for time critical reason for example this cause |
| Handover | value is reserved to represent all critical cases where the connection is |
| | likely to be dropped if handover is not performed. |
| TX2_{RELOCoverall} | The reason for the action is expiry of timer TX2_{RELOCoverall}. |
| Expiry | |
| T_{RELOCprep} Expiry | Handover Preparation procedure is cancelled when timer T_{RELOCprep} |
| | expires. |
| Unknown MME | The target eNB belongs to the same pool area of the source eNB and |
| Code | recognizes the MME Group ID. However, the MME Code is |
| | unknown to the target eNB. |
| Unknown New | The action failed because the New eNB UE X2AP ID or the MeNB |
| eNB UE X2AP | UE X2AP ID is unknown. |
| ID | |
| Unknown Old | The action failed because the Old eNB LIE X2AP ID or the SeNB UE |
| eNB UE X2AP | X2AP ID is unknown. |
| ID | |
| Unknown Pair of | The action failed because the pair of UE X2 AP IDs is unknown. |
| UE X2AP ID | |
| Encryption | The target eNB is unable to support any of the encryption and/or |
| And/Or Integrity | integrity protection algorithms supported by the UE, or the en-gNB is |
| Protection | unable to support any of the NR encryption and/or integrity protection |
| Algorithms Not | algorithms supported by the UE for EN-DC operation. |
| Supported | |
| ReportCharacteristicsEmpty | The action failed because there is no characteristic reported. |
| NoReportPeriodicity | The action failed because tire periodicity is not defined. |
| ExistingMeasurementID | The action failed because measurement-ID is already used. |
| Unknown eNB | The action failed because some eNB Measurement-ID is unknown. |
| Measurement ID | |
| Measurement | The eNB can temporarily not provide the requested measurement |
| Temporarily not | object. |
| Available | |
| Load Balancing | The reason for mobility settings change is load balancing. |
| Handover | The reason for mobility settings change is handover optimisation. |
| Optimisation | |
| Value out of | The action failed because the proposed Handover Trigger parameter |
| allowed range | change in the eNB₂ Proposed Mobility Parameters IE is too low or too |
| | high. |
| Multiple E-RAB | The action failed because multiple instances of the same E-RAB had |
| ID Instances | been provided to the eNB. |
| Switch Off | The reason for the action is an ongoing switch off for example the |
| Ongoing | concerned cell will be switched off after offloading and not be |
| | available. It aides the receiving eNB in taking subsequent actions, e.g. |
| | selecting the target cell for subsequent handovers. |
| Not supported | The action failed because the requested QCI is not supported. |
| QCI value | |
| Unspecified | Sent when none of tire above cause values applies but still the cause is |
| | Radio Network Layer related. |
| Measurement not | At least one of the concerned cell(s) does not support the requested |
| Supported For | measurement. |
| The Object | |
| T_{DCoverall} Expiry | The reason for the action is expiry of timer T_{DCoveral}l. |
| T_{DCprep} Expiry | The reason for the action is expiry of timer T_{DCprep.} |
| Action Desirable | The reason for requesting the action is radio related. |
| for Radio | In the current version of this specification applicable for Dual |
| Reasons | Connectivity and EN-DC only. |
| Reduce Load | Load in the cell(group) served by the requesting node needs to be |
| | reduced. |
| | In the current version of this specification applicable for Dual |
| | Connectivity and EN-DC only. |
| Resource | The reason for requesting this action is to improve the load |
| Optimisation | distribution with the neighbour cells. |
| | In the current version of this specification applicable for Dual |
| | Connectivity and EN-DC only. |
| Time Critical | The action is requested for time critical reason for example this cause |
| action | value is reserved to represent all critical cases where radio resources |
| | are likely to be dropped if the requested action is not performed. |
| | In the current version of this specification applicable for Dual |
| | Connectivity and EN-DC only. |
| Target not | Requested action towards the indicated target cell is not allowed for |
| Allowed | the UE in question. |
| | In the current version of this specification applicable for Dual |
| | Connectivity and EN-DC only. |
| No Radio | The cell(s) in the requested node don't have sufficient radio resources |
| Resources | available. |
| Available | In the current version of this specification applicable for Dual |
| | Connectivity and EN-DC only. |
| Invalid QoS | The action was failed because of invalid QoS combination. |
| combination | In the current version of this specification applicable for Dual |
| | Connectivity and EN-DC only. |
| Encryption | The requested eNB is unable to support any of the encryption |
| Algorithms Not | algorithms supported by the UE. |
| Supported | In the current version of this specification applicable for Dual |
| | Connectivity and EN-DC only. |
| Procedure | The sending node cancelled the procedure due to other urgent actions |
| cancelled | to be performed. |
| | In the current version of this specification applicable for Dual |
| | Connectivity and EN-DC only. |
| RRM purpose | The procedure is initiated due to node internal RRM purposes. |
| | In the current version of this specification applicable for Dual |
| | Connectivity and EN-DC only. |
| Improve User Bit | The reason for requesting this action is to improve the user bit rate. |
| Rate | In the current version of this specification applicable for Dual |
| | Connectivity and EN-DC only. |
| User Inactivity | The action is requested due to user inactivity on all E-RABs, e.g., S1 |
| | is requested to be released in order to optimise the radio resources; or |
| | SeNB/en-gNB didn't see activity on the DRB recently. |
| | In the current version of this specification applicable for Dual |
| | Connectivity and EN-DC only. |
| Radio Connection | The action is requested due to losing the radio connection to the UE. |
| With UE Lost | In the current version of this specification applicable for Dual |
| | Connectivity and EN-DC only. |
| Failure in the | Radio interface procedure lias failed. |
| Radio Interface | In the current version of this specification applicable for Dual |
| Procedure | Connectivity and EN-DC only. |
| Bearer Option not | The requested bearer option is not supported by the sending node. |
| Supported | In the current version of this specification applicable for Dual |
| | Connectivity and EN-DC only. |
| MCG Mobility | The procedure is initiated due to mobility related at MCG radio |
| | resource. |
| SCG Mobility | The procedure is initiated due to mobility related at SCG radio |
| | resource. |
| Count reaches | Indicates the PDCP COUNT for UL or DL reached the max value and |
| max value | the bearer may be released. |
| Unknown Old en- | The action failed because the Old en-gNB UE X2AP ID or the SeNB |
| gNB UE X2AP | UE X2AP ID is unknown. |
| ID | |
| PDCP Overload | The procedure is initiated due to PDCP resource limitation. |
| Prepared Target | The reason for cancelling handover is due to change of target cell |
| Cell | configuration or prepared resources, expecting handover re-initiation |
| Configuration | from the source eNB. |
| change | |

| Transport | |
|---|---|
| Network Layer | |
| cause | Meaning |
| Transport | The required transport resources are not available. |
| resource | |
| unavailable | |
| Unspecified | Sent when none of the above cause values applies but still the cause is |
| | Transport Network Layer related |

| Protocol cause | Meaning |
|---|---|
| Abstract Syntax | The received message included an abstract syntax error and the |
| Error (Reject) | concerned criticality indicated “reject” (see sub clause 10.3 of TS |
| | 36.413 [4]). |
| Abstract Syntax | The received message included an abstract syntax error and the |
| Error (Ignore and | concerned criticality indicated “ignore and notify” (see sub clause |
| Notify) | 10.3 of TS 36.413 [4]). |
| Abstract syntax | The received message contained IEs or IE groups in wrong order or |
| error (falsely | with too many occurrences (see sub clause 10.3 of TS 36.413 [4]). |
| constructed | |
| message) | |
| Message not | The received message was not compatible with the receiver state (see |
| Compatible with | sub clause 10.4 of TS 36.413 [4]). |
| Receiver State | |
| Semantic Error | The received message included a semantic error (see sub clause 10.4 |
| | of TS 36.413 [4]). |
| Transfer Syntax | The received message included a transfer syntax error (see sub clause |
| Error | 10.2 of TS 36.413 [4]). |
| Unspecified | Sent when none of the above cause values applies but still the cause is |
| | Protocol related |

| Miscellaneous | |
|---|---|
| cause | Meaning |
| Control | eNB control processing overload |
| Processing | |
| Overload | |
| Hardware Failure | eNB hardware failure |
| Not enough User | eNB has insufficient user plane processing resources available. |
| Plane Processing | |
| Resources | |
| O&M | Operation and Maintenance intervention related to eNB equipment |
| Intervention | |
| Unspecified | Sent when none of the above cause values applies and the cause is not |
| | related to any of the categories Radio Network Layer, Transport |
| | Network Layer or Protocol |

For TS 38.423

9.2.3.2 Cause

The purpose of the Cause IE is to indicate the reason for a particular event for the XnAP protocol.

| | | | | |
|---|---|---|---|---|
| IE/Group | | | IE Type and | |
| Name | Presence | Range | Reference | Semantics Description |

| | | |
|---|---|---|
| CHOICE | M | |
| Cause | | |
| Group | | |
| >Radio | | |
| Network | | |
| Layer | | |
| >>Radio | M | ENUMERATED |
| Network | | (Cell not Available, |
| Layer | | Handover Desirable |
| Cause | | for Radio Reasons, |
| | | Handover Target not |
| | | Allowed, |
| | | Invalid AMF Set ID, |
| | | No Radio Resources |
| | | Available in Target |
| | | Cell, |
| | | Partial Handover, |
| | | Reduce Load in |
| | | Serving Cell, |
| | | Resource |
| | | Optimisation |
| | | Handover, |
| | | Time Critical |
| | | Handover, |
| | | TXnRELOCoverall |
| | | Expiry, |
| | | TXnRELOCprep |
| | | Expiry, |
| | | Unknown GUAMI |
| | | ID, |
| | | Unknown Local NG- |
| | | RAN node UE XnAP |
| | | ID, |
| | | inconsistent Remote |
| | | NG-RAN node UE |
| | | XnAP ID, |
| | | Encryption And/Or |
| | | Integrity Protection |
| | | Algorithms Not |
| | | Supported, |
| | | Protection |
| | | Algorithms Not |
| | | Supported, |
| | | Multiple PDU |
| | | Session ID Instances, |
| | | Unknown PDU |
| | | Session ID, |
| | | Unknown QoS Flow |
| | | ID, |
| | | Multiple QoS Flow |
| | | ID Instances, |
| | | Switch Off Ongoing, |
| | | Not supported 5QI |
| | | value, |
| | | TXnDCoverall |
| | | Expity, |
| | | TXnDCprep Expiry, |
| | | Action Desirable for |
| | | Radio Reasons, |
| | | Reduce Load, |
| | | Resource |
| | | Optimisation, |
| | | Time Critical action, |
| | | Target not Allowed, |
| | | No Radio Resources |
| | | Available, |
| | | Invalid QoS |
| | | combination, |
| | | Encryption |
| | | Algorithms Not |
| | | Supported, |
| | | Procedure cancelled, |
| | | RRM purpose, |
| | | Improve User Bit |
| | | Rate, |
| | | User Inactivity, |
| | | Radio Connection |
| | | With UE Lost, |
| | | Failure in the Radio |
| | | Interface Procedure, |
| | | Bearer Option not |
| | | Supported, |
| | | UP integrity |
| | | protection not |
| | | possible, UP |
| | | confidentiality |
| | | protection not |
| | | possible, |
| | | Resources not |
| | | available for the |
| | | slice(s), |
| | | UE Maximum |
| | | integrity protected |
| | | data rate reason, |
| | | CP Integrity |
| | | Protection Failure, |
| | | UP Integrity |
| | | Protection Failure, |
| | | Slice(s) not supported |
| | | by NG-RAN, |
| | | MN Mobility, |
| | | SN Mobility, |
| | | Count reaches max |
| | | value, |
| | | Unknown Old NG- |
| | | RAN node UE XnAP |
| | | ID, |
| | | PDCP Overload, |
| | | DRB ID not |
| | | available, |
| | | Unspecified, |
| | | Prepared Target Cell |
| | | Configuration |
| | | Change. |
| | | . . . , |
| | | UE Context ID not |
| | | known, Non- |
| | | relocation of context) |
| >Transport | | |
| Layer | | |
| >>Transport | M | ENUMERATED |
| Layer | | (Transport Resource |
| Cause | | Unavailable, |
| | | Unspecified, |
| | | . . .) |
| >Protocol | | |
| >>Protocol | M | ENUMERATED |
| Cause | | (Transfer Syntax |
| | | Error, |
| | | Abstract Syntax Error |
| | | (Reject), |
| | | Abstract Syntax Error |
| | | (Ignore and Notify), |
| | | Message not |
| | | Compatible with |
| | | Receiver State, |
| | | Semantic Error, |
| | | Abstract Syntax Error |
| | | (Falsely Constructed |
| | | Message), |
| | | Unspecified, . . .) |
| >Misc | | |
| >>Miscellaneous | M | ENUMERATED |
| Cause | | (Control Processing |
| | | Overload, |
| | | Hardware Failure, |
| | | O&M Intervention, |
| | | Not enough User |
| | | Plane Processing |
| | | Resources, |
| | | Unspecified, . . .) |

Thus, the Prepared Target Cell Configuration Change indicates that the CHO (and/or continuous packet connectivity (CPC)) resources for a UE are to be changed. The meaning of the different cause values is specified in the following table. In general, “not supported” cause values indicate that the related capability is missing. On the other hand, “not available” cause values indicate that the related capability is present, but insufficient resources were available to perform the requested action.

| Radio Network | |
|---|---|
| Layer cause | Meaning |
| Cell not Available | The concerned cell is not available. |
| Handover Desirable | The reason for requesting handover is radio related. |
| for Radio Reasons | |
| Handover Target | Handover to the indicated target cell is not allowed for the UE in |
| not Allowed | question. |
| Invalid AMF Set ID | The target NG-RAN node doesn't belong to the same AMF Set of |
| | the source NG-RAN node, for example NG handovers should be |
| | attempted instead. |
| No Radio Resources | The target cell doesn't have sufficient radio resources available. |
| Available in Target | |
| Cell | |
| Partial Handover | Provides a reason for the handover cancellation. The target NG- |
| | RAN node did not admit all PDU Sessions included in the |
| | HANDOVER REQUEST and the source NG-RAN node estimated |
| | service continuity for the UE would be better by not proceeding |
| | with handover towards this particular target NG-RAN node. |
| Reduce Load in | Load in serving cell needs to be reduced. When applied to handover |
| Serving Cell | preparation, it indicates the handover is triggered due to load |
| | balancing. |
| Resource | The reason for requesting handover is to improve the load |
| Optimisation | distribution with the neighbour cells. |
| Handover | |
| Time Critical | Handover is requested for time critical reason for example this |
| Handover | cause value is reserved to represent all critical cases where the |
| | connection is likely to be dropped if handover is not performed. |
| TXn_{RELOCoverall} | The reason for the action is expiry of timer TXn_{RELOCoverall}. |
| Expiry | |
| TXn_{RELOCprep} Expiry | Handover Preparation procedure is cancelled when timer |
| | TXn_{RELOCprep} expires. |
| Unknown GUAMI | The target NG-RAN node belongs to the same AMF Set of the |
| ID | source NG-RAN node and recognizes the AMF Set ID. However, |
| | the GUAMI value is unknown to the target NG-RAN node. |
| Unknown Local | The action failed because the receiving NG-RAN node does not |
| NG-RAN node UE | recognise the local NG-RAN node UE XnAP ID. |
| XnAP ID | |
| Inconsistent Remote | The action failed because the receiving NG-RAN node considers |
| NG-RAN node UE | that the received remote NG-RAN node UE XnAP ID is |
| XnAP ID | inconsistent . . . |
| Encryption And/Or | The target NG-RAN node is unable to support any of the |
| Integrity- Protection | encryption and/or integrity protection algorithms supported by the |
| Algorithms Not | UE. |
| Supported | |
| Multiple PDU | The action failed because multiple instances of the same PDU |
| Session ID | Session had been provided to the NG-RAN node. |
| Instances | |
| Unknown PDU | The action failed because the PDU Session ID is unknown in the |
| Session ID | NG-RAN node. |
| Unknown QoS | The action failed because the QoS Flow- ID is unknow-n in the NG- |
| Flow ID | RAN node. |
| Multiple QoS Flow | The action failed because multiple instances of the same QoS flow- |
| ID Instances | had been provided to the NG-RAN node. |
| Switch Off Ongoing | The reason for the action is an ongoing switch off for example the |
| | concerned cell will be switched off after offloading and not be |
| | available. It aides the receiving NG-RAN node in taking |
| | subsequent actions, e.g. selecting the target cell for subsequent |
| | handovers. |
| Not supported 5QI | The action failed because the requested 5QI is not supported. |
| value | |
| TXn_{DCoverall} Expiry | The reason for the action is expiry of timer TXn_{DCoverall}. |
| TXn_{DCprep} Expiry | The reason for the action is expiry of timer TXn_{DCprep} |
| Action Desirable for | The reason for requesting the action is radio related. |
| Radio Reasons | In the current version of this specification applicable for Dual |
| | Connectivity only. |
| Reduce Load | Load in the cell(group) served by the requesting node needs to be |
| | reduced. |
| | In the current version of this specification applicable for Dual |
| | Connectivity only. |
| Resource | The reason for requesting this action is to improve the load |
| Optimisation | distribution with the neighbour cells. |
| | In the current version of this specification applicable for Dual |
| | Connectivity only. |
| Time Critical action | The action is requested for time critical reason for example this |
| | cause value is reserved to represent all critical cases where radio |
| | resources are likely to be dropped if the requested action is not |
| | performed. |
| | In the current version of this specification applicable for Dual |
| | Connectivity only. |
| Target not Allowed | Requested action towards the indicated target cell is not allowed for |
| | the UE in question. |
| | In the current version of this specification applicable for Dual |
| | Connectivity only. |
| No Radio Resources | The cell(s) in the requested node don't have sufficient radio |
| Available | resources available. |
| | In the current version of tills specification applicable for Dual |
| | Connectivity only. |
| Invalid QoS | The action was failed because of invalid QoS combination. |
| combination | In the current version of tills specification applicable for Dual |
| | Connectivity only. |
| Encryption | The requested NG-RAN node is unable to support any of the |
| Algorithms Not | encryption algorithms supported by the UE. |
| Supported | In the current version of this specification applicable for Dual |
| | Connectivity only. |
| Procedure cancelled | The sending node cancelled the procedure due to other urgent |
| | actions to be performed. |
| | In the current version of this specification applicable for Dual |
| | Connectivity only. |
| RRM purpose | The procedure is initiated due to node internal RRM purposes. |
| | In the current version of this specification applicable for Dual |
| | Connectivity only. |
| Improve User Bit | The reason for requesting this action is to improve the user bit rate. |
| Rate | In the current version of this specification applicable for Dual |
| | Connectivity only. |
| User Inactivity | The action is requested due to user inactivity on all PDU Sessions. |
| | The action may be performed on several levels: |
| | on UE Context level, if NG is requested to be released in order |
| | to optimise the radio resources; or S-NG-RAN node didn't see |
| | activity on the PDU session recently. |
| | on PDU Session Resource or DRB or QoS flow level, e.g. if |
| | Activity Notification indicate lack of activity |
| | In the current version of this specification applicable for Dual |
| | Connectivity only. |
| Radio Connection | The action is requested due to losing the radio connection to the |
| With UE Lost | UE. |
| | In the current version of this specification applicable for Dual |
| | Connectivity only. |
| Failure in the Radio | Radio interface procedure has failed. |
| Interface Procedure | In the current version of tins specification applicable for Dual |
| | Connectivity only. |
| Bearer Option not | The requested bearer option is not supported by the sending node. |
| Supported | In the current version of this specification applicable for Dual |
| | Connectivity only. |
| UP integrity | The PDU session cannot be accepted according to the required user |
| protection not | plane integrity protection policy. |
| possible | |
| UP confidentiality | The PDU session cannot be accepted according to the required user |
| protection not | plane confidentiality protection policy. |
| possible | |
| Resources not | The requested resources are not available for the slice(s). |
| available for the | |
| slice(s) | |
| UE Maximum | The request is not accepted in order to comply with the maximum |
| integrity protected | data rate for integrity protection supported by the UE. |
| data rate reason | |
| CP Integrity | The request is not accepted due to failed control plane integrity |
| Protection Failure | protection. |
| UP Integrity | The procedure is initiated because the SN (hosting node) detected |
| Protection Failure | an Integrity Protection failure in the UL PDU coming from the MN. |
| Slice(s) not | The failure is due to slice(s) not supported by the NG-RAN node. |
| supported by NG- | |
| RAN | |
| MN Mobility | The procedure is initiated due to relocation of the M-NG-RAN |
| | node UE context. |
| SN Mobility | The procedure is initiated due to relocation of the S-NG-RAN node |
| | UE context. |
| Couth reaches max | Indicates the PDCP COUNT for UL or DL reached the max value |
| value, | and the bearer may be released. |
| Unknown Old NG- | The action failed because the Old NG-RAN node UE XnAP ID or |
| RAN node UE | the S-NG-RAN node UE XnAP ID is unknown. |
| XnAP ID | |
| PDCP Overload | The procedure is initiated due to PDCP resource limitation. |
| DRB ID not | The action failed because the M-NG-RAN node is not able to |
| available | provide additional DRB IDs to the S-NG-RAN node. |
| Unspecified | Sent for radio network layer cause when none of the specified cause |
| | values applies. |
| UE Context ID not | The context retrieval procedure cannot be performed because the |
| known | UE context cannot be identified. |
| Non-relocation of | The context retrieval procedure is not performed because the old |
| context | RAN node has decided not to relocate the UE context. |
| Prepared Target | The reason for cancelling handover is due to change of target cell |
| Cell Configuration | configuration or prepared resources, expecting handover re- |
| Change | initiation from the source NG-RAN node. |

| Transport Layer | |
|---|---|
| cause | Meaning |
| Unspecified | Sent when none of the above cause values applies but still the |
| | cause is Transport Network Layer related. |

| NAS cause | Meaning |
|---|---|
| Unspecified | Sent when none of the above cause values applies but still the cause |
| | is NAS related. |

| Protocol cause | Meaning |
|---|---|
| Transfer Syntax | The received message included a transfer syntax error. |
| Error | |
| Abstract Syntax | The received message included an abstract syntax error and the |
| Error (Reject) | concerning criticality indicated “reject”. |
| Abstract Syntax | The received message included an abstract syntax error and the |
| Error (Ignore And | concerning criticality indicated “ignore and notify”. |
| Notify) | |
| Message Not | The received message was not compatible with the receiver state. |
| Compatible With | |
| Receiver State | |
| Semantic Error | The received message included a semantic error. |
| Abstract Syntax | The received message contained IBs or IE groups in wrong order or |
| Error (Falsely | with too many occurrences. |
| Constructed | |
| Message) | |
| Unspecified | Sent when none of the above cause values applies but still the cause |
| | is Protocol related. |
| Miscellaneous | |
| cause | Meaning |
| Control Processing | NG-RAN node control processing overload. |
| Overload | |
| Hardware Failure | NG-RAN node hardware failure. |
| Not enough User | NG-RAN node has insufficient user plane processing resources |
| Plane Processing | available. |
| Resources | |
| O&M Intervention | Operation and Maintenance intervention related to NG-RAN node |
| | equipment. |
| Unspecified | Sent when none of the above cause values applies and the cause is |
| | not related to any of the categories Radio Network Layer, Transport |
| | Network Layer or Protocol. |

In another embodiment the target cell indicates by an additional IE without introducing a new cause value. In the target cell indicates follow-up CHO preparation by an additional IE in the CHO Cancel message without introducing a new cause value. In this case, TS 36.423 and TS 38.423 are as follows:

For TS 36.423

9.1.1.X Conditional Handover Cancel

This message is sent by the target eNB to the source eNB to cancel an ongoing conditional handover.

Direction: target eNB→source eNB.

| IE/Group | | | IE type and | Semantics | | Assigned |
|---|---|---|---|---|---|---|
| Name | Presence | Range | reference | description | Criticality | Criticality |
| Message Type | M | | 9.2.13 | | YES | ignore |
| Old eNB UE | M | | eNB UE X2AP | Allocated at | YES | ignore |
| X2AP ID | | | ID | the source | | |
| | | | 9.2.24 | eNB | | |
| New eNB UE | M | | eNB UE X2AP | Allocated at | YES | reject |
| X2AP ID | | | ID | the target | | |
| | | | 9.2.24 | eNB | | |
| Cause | M | | 9.2.6 | | YES | ignore |
| Old eNB UE | O | | Extended eNB | Allocated at | YES | ignore |
| X2AP ID | | | UE X2AP ID | the source | | |
| Extension | | | 9.2.86 | eNB | | |
| New eNB UE | O | | Extended eNB | Allocated at | YES | reject |
| X2AP ID | | | UE X2AP ID | the target | | |
| Extension | | | 9.2.86 | eNB | | |
| Candidate | | 0 . . . <maxnoofCellsinCHO> | | | YES | reject |
| Cells To Be | | | | | | |
| Cancelled | | | | | | |
| List | | | | | | |
| >Target Cell | M | | ECGI | | — | — |
| ID | | | 9.2.14 | | | |
| >Action | O | | ENUMERATED | | — | — |
| Required | | | (Expecting CHO | | | |
| | | | preparation, . . .) | | | |

| Range bound | Explanation |
|---|---|
| maxnoofCellsinCHO | Maximum no. cells that can be prepared for a conditional handover. |
| | Value is FFS. |

For TS 38.423

9.1.1.B Conditional Handover Cancel

This message is sent by the target NG-RAN node to the source NG-RAN node to cancel an already prepared conditional handover.

Direction: target NG-RAN node→source NG-RAN node.

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| Source NG- | M | | NG-RAN node | Allocated at | YES | ignore |
| RAN node | | | UE XnAP ID | the source NG- | | |
| UE XnAP ID | | | 9.2.3.16 | RAN node. | | |
| Target NG- | M | | NG-RAN node | Allocated at | YES | reject |
| RAN node | | | UE XnAP ID | the target NG- | | |
| UE XnAP ID | | | 9.2.3.16 | RAN node. | | |
| Cause | M | | 9.2.3.2 | | YES | ignore |
| Candidate | | 0 . . . <maxnoofCellsinCHO> | | | YES | reject |
| Cells To Be | | | | | | |
| Cancelled | | | | | | |
| List | | | | | | |
| >Target | M | | NR CGI | | — | — |
| Cell ID | | | 9.2.2.7 | | | |
| >Action | O | | ENUMERATED | | — | — |
| Required | | | (Expecting CHO | | | |
| | | | preparation, . . .) | | | |

| Range bound | Explanation |
|---|---|
| maxnoofCellsinCHO | Maximum no. cells that can be prepared for a conditional handover. |
| | Value is FFS. |

In an alternative, the Action Required IE can be a Boolean type to indicate expecting CHO preparation as in the following:

| | | | | |
|---|---|---|---|---|
| >CHO | O | ENUMERATED (True, . . .) | — | — |
| Preparation | | | | |
| Expected | | | | |

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Thus, at least one of A or B, includes one or more of A, one or more of B, or one or more of A and one or more of B. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a fifth generation node B (gNB), the apparatus comprising: processing circuitry; and memory, the processing circuitry to configure the gNB to operate as a source cell to serve a user equipment (UE),
wherein to serve the UE, the processing circuitry is configured to:
encode, for transmission to a target cell, a Handover Request message with an information element (IE) indicating a conditional handover (CHO) request for handover of the UE;
decode, from the target cell, a Handover Request Acknowledgment message with an IE indicating the CHO request; and
decode, from the target cell after reception of the Handover Request Acknowledgment message, a CHO Cancel message containing an IE that indicates the target cell is no longer able to accept handover of the UE from the source cell; and
wherein the memory is configured to store the CHO Cancel message.

2. The apparatus of claim 1, wherein the processing circuitry is further configured to decode, from the target cell, the CHO Cancel message containing a cause IE that indicates resources reserved in the target cell for CHO for the UE are to be changed.

3. The apparatus of claim 1, wherein the processing circuitry is further configured to decode, from the target cell, the CHO Cancel message containing a cause IE that indicates a configuration of the target cell is to be changed.

4. The apparatus of claim 1, wherein at least one of the source cell or target cell is a 5^{th} generation evolved NodeB (gNB).

5. The apparatus of claim 1, wherein the processing circuitry is further configured to decode, from the target cell, the Handover Request Acknowledgment message that contains a transparent container having a HandoverCommand message and a handover command information IE indicating which of a delta configuration from a source cell configuration and a full configuration the UE was used by the target cell to generate the HandoverCommand message.

6. The apparatus of claim 5, wherein the processing circuitry is further configured to:
adjust the source cell configuration;
determine, from the Handover Request Acknowledgment message, which of the delta configuration and the full configuration the target cell is indicated by the handover command information IE; and
determine, after adjustment of the source cell configuration, whether to trigger a CHO modification to the target cell based on a determination which of the delta configuration and the full configuration is indicated by the handover command information IE.

7. The apparatus of claim 6, wherein the processing circuitry is further configured to:
in response to a determination that the delta configuration is indicated by the handover command information IE, encode, for transmission to the target cell, another Handover Request message, the other Handover Request message including the IE indicating the CHO request; and
in response to a determination that the full configuration is indicated by the handover command information IE, avoid encoding of the other Handover Request message for transmission to the target cell.

8. The apparatus of claim 5, wherein handover command information IE indicates whether the full configuration was used by the target cell to generate the HandoverCommand message by a true-false value as to whether the full configuration was used by the target cell to generate the HandoverCommand message.

9. The apparatus of claim 5, wherein handover command information IE indicates whether the full configuration was used by the target cell to generate the HandoverCommand message by an enumerated value as to which of the delta configuration and the full configuration was used by the target cell to generate the HandoverCommand message.

10. The apparatus of claim 1, wherein the processing circuitry is further configured to:
adjust a source cell configuration; and
encode, for transmission to the target cell, another Handover Request message, the other Handover Request message containing a UE Context Information IE, a UE History Information IE a Reprocessing Information IE that indicates whether reprocessing of one or more IEs of a set of IEs is to be performed for CHO modification by the target cell, the set of IEs including UE Context Information IE and UE History Information IE.

11. A computer-readable storage medium that stores instructions for execution by one or more processors of a fifth generation node B (gNB) to configure the gNB to operate as source cell configured to serve a user equipment (UE), the instructions when executed configure the one or more processors to:
encode, for transmission to a target cell, a Handover Request message with an information element (IE) indicating a conditional handover (CHO) request for handover of the UE;
decode, from the target cell, a Handover Request Acknowledgment message with an IE indicating the CHO request; and
decode, from the target cell after reception of the Handover Request Acknowledgment message, a CHO Cancel message containing an IE that indicates the target cell is no longer able to accept handover of the UE from the source cell.

12. The medium of claim 11, wherein the instructions when executed configure the one or more processors to decode, from the target cell, the CHO Cancel message containing a cause IE that indicates resources reserved in the target cell for CHO for the UE are to be changed.

13. The medium of claim 11, wherein the instructions when executed configure the one or more processors to decode, from the target cell, the CHO Cancel message containing a cause IE that indicates a configuration of the target cell is to be changed.

14. The medium of claim 11, wherein the instructions when executed configure the one or more processors to decode, from the target cell, the Handover Request Acknowledgment message that contains a transparent container having a HandoverCommand message and a handover command information IE indicating which of a delta configuration from a source cell configuration and a full configuration the UE was used by the target cell to generate the HandoverCommand message.

15. The medium of claim 14, wherein the instructions when executed configure the one or more processors to:
adjust the source cell configuration;
determine, from the Handover Request Acknowledgment message, which of the delta configuration and the full configuration the target cell is indicated by the handover command information IE;
in response to a determination that the delta configuration is indicated by the handover command information IE, encode, for transmission to the target cell, another Handover Request message, the other Handover Request message including the IE indicating the CHO request; and
in response to a determination that the full configuration is indicated by the handover command information IE, avoid encoding of the other Handover Request message for transmission to the target cell.

16. The medium of claim 11, wherein the instructions when executed configure the one or more processors to:
adjust a source cell configuration; and
encode, for transmission to the target cell, another Handover Request message, the other Handover Request message containing a UE Context Information IE, a UE History Information IE a Reprocessing Information IE that indicates whether reprocessing of one or more IEs of a set of IEs is to be performed for CHO modification by the target cell, the set of IEs including UE Context Information IE and UE History Information IE.

17. An apparatus for a fifth generation node B (gNB), the apparatus comprising: processing circuitry; and memory, the processing circuitry to configure the gNB to operate as a target cell to serve a user equipment (UE),
wherein to serve the UE, the processing circuitry is configured to:
decode, from a source cell serving a user equipment (UE), a Handover Request message with an information element (IE) indicating a conditional handover (CHO) request for handover of the UE;
encode, for transmission to the source cell, a Handover Request Acknowledgment message with an IE indicating the CHO request;
determine, after transmission of the Handover Request Acknowledgment message, that a target cell configuration or prepared resources for the handover of the UE have changed; and
encode, for transmission to the source cell after transmission of the Handover Request Acknowledgment message in response to a determination that the target cell configuration or prepared resources for the handover of the UE have changed, a CHO Cancel message containing an IE that indicates the target cell is no longer able to accept handover of the UE from the source cell; and
wherein the memory is configured to store the CHO Cancel message.

18. The apparatus of claim 17, wherein the processing circuitry is further configured to encode, for transmission to the source cell, the Handover Request Acknowledgment message that contains a transparent container having a HandoverCommand message and a handover command information IE indicating which of a delta configuration from a source cell configuration and a full configuration the UE was used by the target cell to generate the HandoverCommand message.

19. The apparatus of claim 18, wherein the processing circuitry is further configured to decode, from the source cell, another Handover Request message including the IE indicating the CHO request only if the delta configuration is indicated by the handover command information IE.

20. The apparatus of claim 17, wherein the processing circuitry is further configured to decode, from the source cell, another Handover Request message, the other Handover Request message containing a UE Context Information IE, a UE History Information IE a Reprocessing Information IE that indicates whether reprocessing of one or more IEs of a set of IEs is to be performed for CHO modification by the target cell, the set of IEs including UE Context Information IE and UE History Information IE.
